(19) United States
(12) Patent Application Publication
(10) Pub. No.: US 2007/0176342 A1
(43) Pub. Date: Aug. 2, 2007

(54) Single-handed clamp clip

(75) Inventor: Zbigniew Noniewicz, Kempenich (DE)

Correspondence Address: Michael S Leonard;Everest Intellectual Property Law Group, PO Box 708, Northbrook, IL, 60065, US

(73) Assignee: WOLFCRAFT, GMBH, KEMPENICH (DE)

(21) Appl. No.: 10/592,260

(22) PCT Filed: Feb. 25, 2005
(86) PCT No.: PCT/EP05/50811

§ 371 Date: Sep. 8, 2006

(30) Foreign Application Priority Data
Mar. 10, 2004 (DE) 10 2004 011 636.9

(51) Int. Cl. B25B 1/00

(52) U.S. Cl. 269/6

(57) ABSTRACT

A clamping tool, particularly a clamping clip, is provided with first and second clamping jaw carriers which are associated with a track and which respectively bear a clamping jaw. At least the first clamping jaw carrier can be displaced along the track in one direction by a stepped shifting gear mechanism and is prevented from being displaced in the opposite direction by a detachable return locking element and can be displaced along the track.

### CROSS REFERENCE TO RELATED APPLICATION

This application claims priority of German Patent Application Number 102004011636.9, filed Mar. 10, 2004, and International Application Number PCT/EP2005/050811, filed Feb. 25, 2005, which are incorporated by reference.

### BACKGROUND OF THE INVENTION

The invention relates to a clamping tool, in particular a clamping clip, having first and second clamping jaw carriers which are associated with a track and which respectively bear a clamping jaw, wherein at least the first clamping jaw carrier can be displaced along the track in one direction by a stepped shifting gear mechanism and is prevented from moving in the opposite direction by a releasable return locking element.

A clamping tool is known from DE 197 31 579 A1, in which the first clamping jaw carrier may be displaced with respect to the track. The second clamping jaw carrier rests in a reversible but stationary manner at the end of the track.

### SUMMARY OF THE INVENTION

An advantage of the present invention can be to provide a clamping tool so as to improve the utility thereof.

In an embodiment, the present invention provides that also the second clamping jaw carrier may be displaced along the track. According to the invention a releasable return locking element is associated with the second clamping jaw carrier. The return locking elements for both clamping jaw carriers act in opposite directions, thereby enabling the clamping jaws to be moved together into a clamped position or moved apart from each other into a spread position. In an embodiment of the invention, the stepped shifting gear mechanism and/or the return locking elements have a clamping lever which may be displaced against the restoring force of a spring. Each of these clamping levers may form a clamping edge by which the clamping lever along with the track may be tilted. To this end, the track preferably passes through an aperture in the clamping lever. Two diametrically opposed edges of the aperture form the clamping edges. In an embodiment of the invention, the first clamping jaw carrier cooperates with a spring which at one end is supported on the track and at the other end is supported on the first clamping jaw carrier. The spring preferably acts in the clamping direction of the first clamping jaw carrier. The invention provides that the spring supported on the end of the track impinges on the clamping jaw carrier in the clamping direction, and the return locking element acting in the opposite direction exerts a retention force directed opposite to the spring elastic force and exceeding same. As a result of this design, a clamping jaw spring acts on the first clamping jaw carrier. When the return locking element is not actuated, it withstands the force from the clamping jaw spring, although the first clamping jaw carrier may also be displaced in the clamping direction by overcoming only the frictional force exerted by the return locking element in the clamping direction. This may be achieved, for example, by actuating the stepped shifting gear mechanism. If, on the other hand, the return locking element is placed in the released position, the first clamping jaw carrier may be displaced in both directions. The displacement in the direction opposite to the clamping direction is associated with a compression of the clamping jaw spring. The displacement in the clamping direction is brought about by relaxing the clamping jaw spring. The path of this displacement may be limited by a track stop. This design provides a simpler positioning of the clamping tool on the workpiece and the clamping jaw spring may be tightened. The clamping jaw associated with the first clamping jaw carrier may be placed in a contact position on one side of the workpiece. The second clamping jaw carrier may be displaced in the clamping direction without releasing the return locking element associated therewith, until the clamping jaw for the second clamping jaw carrier is situated just in front of the corresponding contact surface of the workpiece or has already contacted the workpiece. If the return locking element for the first clamping jaw is then released, the clamping jaw spring displaces the track until both clamping jaws are in a contacting position on the workpiece. By actuating the clamping lever associated with the stepped shifting gear mechanism one or more times, the clamping jaws may be placed in a clamped position. In an embodiment of the invention, the clamping lever of the return locking element for the first clamping jaw carrier is rigidly connected to a release handle. This release handle may project through an aperture in the hand grip. The above-referenced frictional force, which prevents displacement of the first clamping jaw carrier in the clamping direction by the clamping jaw spring, is preferably exerted by a leaf spring. This leaf spring provides the restoring force against which the release handle is moved from a locked to a released position. The leaf spring may be inserted into a cavity in a hand grip for the first clamping jaw carrier. One free end of the leaf spring may project beneath an extension of the clamping lever. The clamping lever may have a Z shape, with the release handle being associated with the free Z leg. The release handle may be thumb-activated; it is located on a side of the hand grip facing away from the actuating handle for the stepped shifting gear mechanism.

In an embodiment, each of the two clamping jaws may be swiveled about a respective axis at the end of an arm of the associated clamping jaw carrier, the end of the arm having a rounded or roof-like surface. This surface may be associated with a stop base or a support base. By means of its two flanks the clamping jaw is connected to this base, so that the clamping jaw reaches a stop position at both of its extreme inclination positions. The back side of the clamping jaw may either be tangential to the roof-like surface or be supported on the rounded surface in any swiveled position.

In an embodiment, at least one slide which is displaceably associated with the track between the two clamping jaw carriers and which forms a supporting surface for the workpiece. The slide may be placed in a position between the two clamping jaws. In this position the supporting surface of the slide is used to support the workpiece. This is particularly advantageous when the clamping tool is used in a stationary manner. To this end, one of the two clamping jaw carriers may form a bearing surface to the rear of the clamping arm by which the clamping tool may be placed on a workbench. In an embodiment of the invention, the slide also has a bearing surface facing away from the supporting surface. This bearing surface is preferably aligned with the bearing surface for the clamping jaw carrier. In particular, this bearing surface is aligned with the bearing surface for the second clamping jaw carrier. It is not necessary for the first clamping jaw carrier to have a bearing surface. It is sufficient for a slide to optionally be associated with this clamping jaw carrier. This slide may be a second slide which rests on the top side of the workbench, close to the edge thereof. The actuating mechanism for the first clamping jaw comprising a release lever, handle, and clamping lever may be situated in front of the edge of the workbench. To avoid unfavorable leverage forces as the result of a projecting free end of the track, it is advantageous for the track to be displaceable with respect to both clamping jaw carriers. The track may be associated with the two clamping jaw carriers in such a way that the projection of the track extends beyond the workbench, so that no leverage forces, which could cause the clamping tool to tip from the workbench, act on the slide situated close to the edge of the workbench. In an embodiment of the invention, an actuating section of the clamping lever for, in particular, the second clamping jaw carrier projects into a depression associated with the bearing surface. This depression is a recessed grip. If the clamping tool is used resting stationarily on the top side of a workbench, it is not possible to access the actuating section of the clamping lever. The return locking element for the second clamping jaw carrier therefore cannot be actuated. The spring impinging on the clamping lever may be associated with the border of the depression. It is advantageous for the slide, which has an essentially rectangular cross section, to be able to make a clip connection with the clamping jaw carrier associated with the slide. To this end, the clamping jaw carrier may have a spring tongue which is clipped into a corresponding catch recess in the slide.

Additional features and advantages of the present invention are described in, and will be apparent from, the following Detailed Description of the Invention and the figures.

### BRIEF DESCRIPTION OF THE FIGURES

Exemplary embodiments of the invention are explained below with reference to the accompanying drawings, which show the following:

FIG. 1 shows a view of a first exemplary embodiment of the invention, having a partially pretensioned clamping jaw spring;

FIG. 2 shows an illustration according to FIG. 1, having a first clamping jaw carrier displaced up to a stop 15;

FIG. 3 shows an illustration according to section III-III in FIG. 2;

FIG. 4 shows an illustration according to FIG. 3 in a tilted position of the clamping jaw;

FIG. 5 shows an illustration according to FIG. 3, showing the clamping jaw tilted in the other direction;

FIG. 6 shows a section according to line VI-VI in FIG. 3;

FIG. 7 shows a second exemplary embodiment of the invention in a side view, having slides positioned between the two clamping jaws;

FIG. 8 shows an illustration according to FIG. 7 in which the slides make a clip connection with the associated clamping jaws;

FIG. 9 shows an illustration according to FIG. 7 in which a slide makes a clip connection with the first clamping jaw carrier;

FIG. 10 shows a section according to line X-X through a slide;

FIG. 11 shows a section according to line XI-XI in FIG. 9;

FIG. 12 shows a third exemplary embodiment of the invention;

FIG. 13 shows an enlarged illustration of a clamping jaw according to line XIII-XIII in FIG. 12;

FIG. 14 shows an illustration according to FIG. 13 in an extreme tipped position of the clamping jaw;

FIG. 15 shows an illustration according to FIG. 13, in another extreme tipped position of the clamping jaw; and

FIG. 16 shows a section according to line XVI-XVI in FIG. 13.

### DETAILED DESCRIPTION OF THE INVENTION

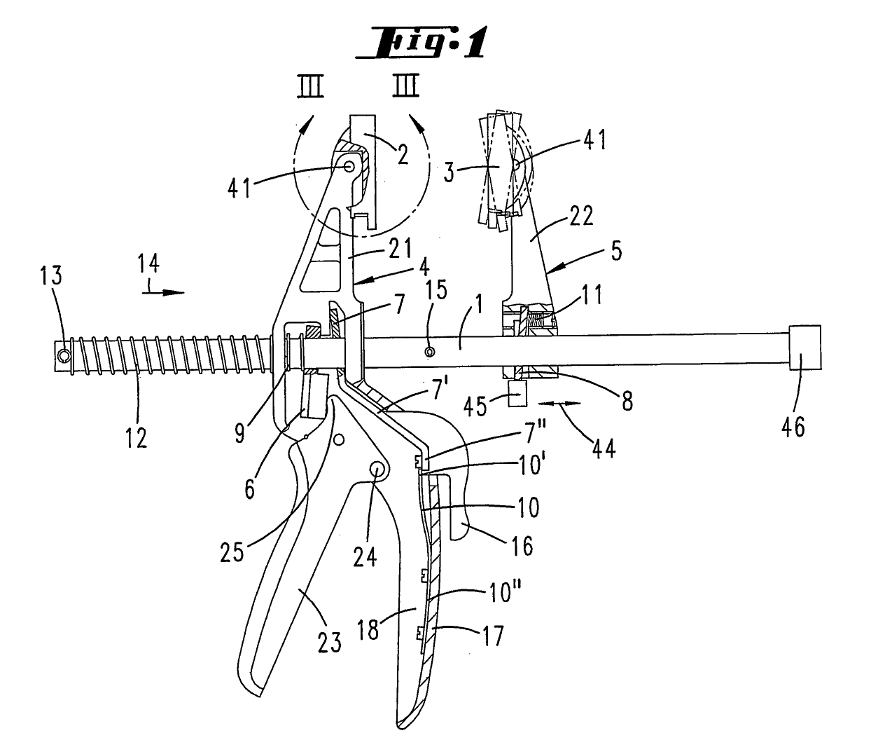

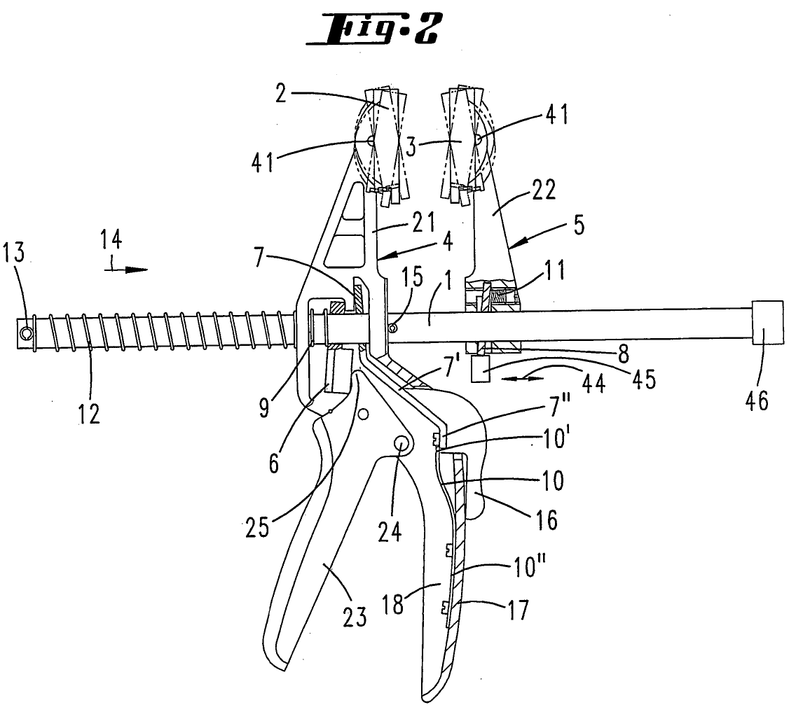

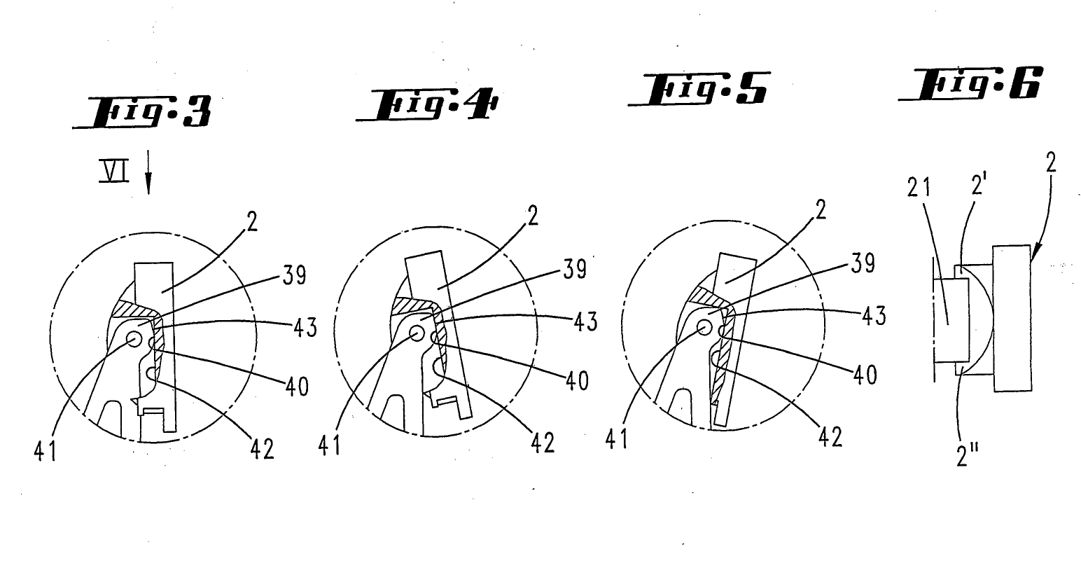

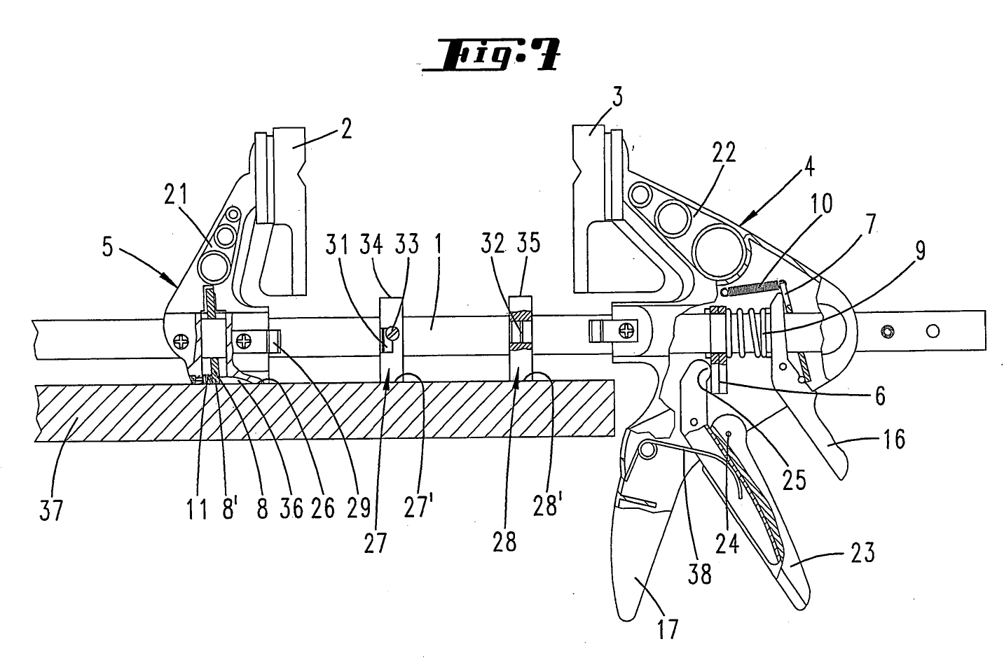

The first exemplary embodiment illustrated in FIGS. 1 through 6 is a single-handed clamping clip which has a first clamping jaw carrier 4 bearing a clamping jaw 2 which is pivotably movable on an arm 21 about an axis 41. The first clamping jaw carrier 4 can be displaced on a metal track 1 having a rectangular cross section. The clamping direction of the first clamping jaw carrier 4 is denoted by reference numeral 14. The first clamping jaw carrier 4 may be pushed or, by actuation of a stepped shifting gear mechanism, displaced in the direction 14. To this end, the operator's hand surrounds a hand grip 17 and a clamping lever 23 which extends parallel to the hand grip 17. The clamping lever 23 is able to pivot about a pivot axis 24 associated with the root of the hand grip 17. When the clamping lever 23, optionally spring-loaded by a spring (not illustrated), is pivoted, the pressure shoulder 25 is pressed against a drive lever 6.

As a result of the torque applied to the drive lever 6 the walls of an aperture in the drive lever 6 tilt, causing the track 1 to project on the two narrow sides of the track. The drive lever 6 remains stationary on the track, whereas the clamping jaw carrier 4 is displaced in the direction of the arrow 14 toward a second clamping jaw carrier 5. Accompanying this displacement, the drive lever 6 moves relative to a bearing cavity in the clamping jaw carrier 4 in which a return locking element 9 is also situated. This return locking element 9 is supported on the base of the bearing cavity and also on the drive lever 6 in such a way that the drive lever 6 is displaced into a transverse position with respect to the track 1 after the clamping lever 23 is released, thereby eliminating the clamping effect.

Motion of the first clamping jaw 4 opposite the direction of the arrow 14 is usually not possible, since in this normal position a locking lever 7 for a return locking element together with the track 1 is in a tilted position. The locking lever 7 has an essentially Z-shaped design. The angled middle section 7′ of the locking lever 7 runs essentially parallel along a housing flank of the clamping jaw carrier 4. A release handle 16 projecting through an aperture in the hand grip 17 is located in the end region of the middle section 7′ and the end section 7″. The release handle 16, i.e., an end-side projection 7″ of the locking lever 7, is impinged on by the end 10′ of a leaf spring 10. The other end 10″ of the leaf spring 10 is fastened in the grip cavity 18 by means of two screws. The pretensioning of the leaf spring 10 causes the locking lever 7 to lie in a continuous tilted position with respect to the track 1. The tensile force from the leaf spring 10 is also large enough to exert in the direction of the arrow 14 a frictional force between the locking lever 7 and the track 1 which is larger than the force from the tightened clamping jaw spring 12. As a result, although it is basically possible for the first clamping jaw carrier 4 to move in the direction of the arrow 14, the first clamping jaw carrier is displaced by the force of the spring 12 in the direction of the arrow 14 only when the release handle 16 is actuated in the release direction.

A track stop formed by a spring pin 15 limits the displacement path of the first clamping jaw carrier 4 along the track 1. The stop 13 against which the clamping jaw spring 12 is supported is likewise formed by a spring pin.

Directly opposite the clamping jaw 2 a clamping jaw 3 is present on a second clamping jaw carrier 5. This clamping jaw as well is mounted on an arm 22 about a pivot axis 41. The second clamping jaw carrier 5 likewise has a return locking element. This return locking element is formed by a locking lever 8 which in its normal position is situated in a tilted position with respect to the track such that the second clamping jaw carrier 5 cannot be displaced in the direction of the arrow 14. As a result of a corresponding impingement of force, however, the second clamping jaw carrier 5 can be pushed on the track 1 in the opposite direction. The second clamping jaw carrier 5 cannot be displaced in the direction of the arrow 14 until the return locking element 8 is released by swiveling of the locking lever.

The locking lever 8 is held in the locked position by a helical compression spring 11. The free end of the locking lever 8 projects from an opening in the clamping jaw carrier 5, and at that location forms an actuation section 45. This actuation section can be displaced in the direction of the arrow 44 in order to place the locking lever 8, which is usually tilted with respect to the track 1, in a transverse position with respect to the track 1 in which the track 1 freely projects through the aperture in the locking lever 8. An end cap 46 prevents the second clamping jaw carrier 5 from being pulled off the track 1. It is still possible to remove the clamping jaw carriers 4, 5 from the track 1 in order to slide them back onto the track 1 in the opposite direction. In that case, the action of the two clamping jaws 2, 3 is not toward one another, but, instead, away from one another in the form of a spreading element.

The mode of functioning of this exemplary embodiment is as follows:

If the release handle 16 is actuated when the first clamping jaw carrier 5 is in the position illustrated in FIG. 1, the frictional force exerted by the locking lever 7 on the track 1 is reduced in such a way that the force from the clamping jaw spring 12 displaces the track 1 relative to the first clamping jaw carrier 4. Accompanying this displacement, the clamping jaw 3 moves toward the clamping jaw 2.

Each of the two arms 21, 22 bears on its end a clamping jaw 2, 3, respectively, which is pivotably displaceable about an axis 41. The clamping jaw 2 forms two flanks 2′, 2″ which are separated at a distance from each other and by means of which the clamping jaw 2 is fastened via a pin at axis 41 to a base 39 of the arm. The base has a round surface against which the back side 42 of the clamping jaw makes contact. The back side 42 of the clamping jaw rests against the rounded surface 40, regardless of the pivot angle of the clamping jaw 2.

The extreme angles of inclination of the clamping jaw with respect to the arm 21 or 22 are limited by a stop. A stop surface 43, i.e., a section of the arm 21, is used for this purpose.

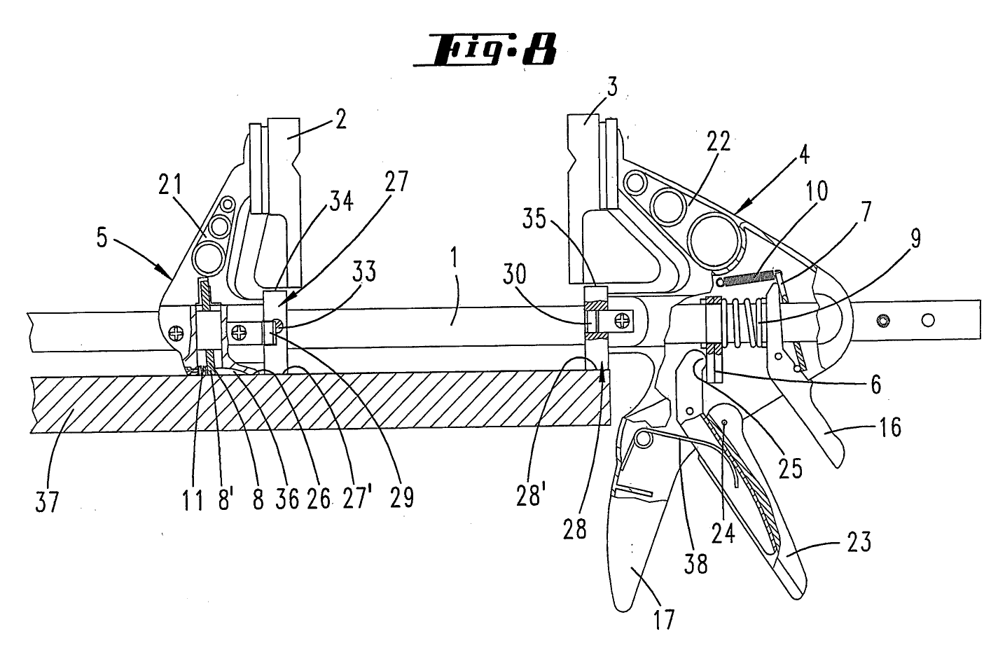

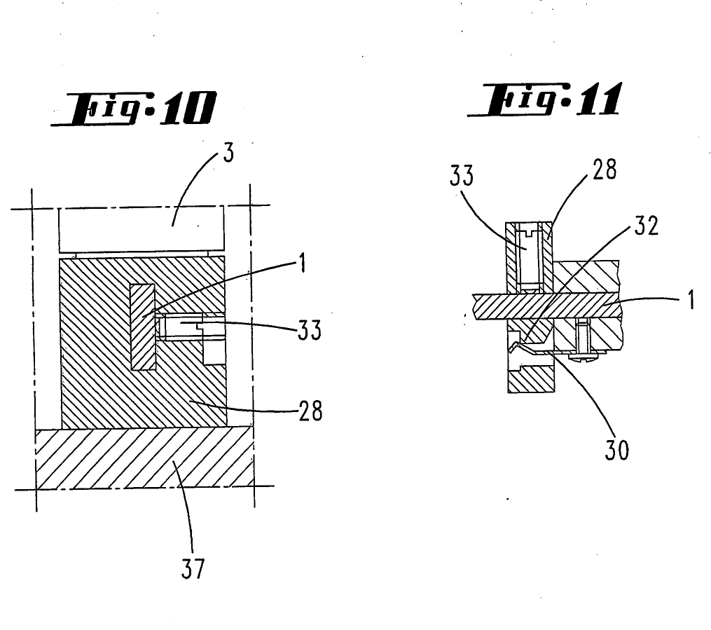

In the second exemplary embodiment illustrated in FIGS. 7 through 11, a total of two rectangular slides 27, 28 which are displaceable on the track are located on the segment of the track 1 between the two clamping jaw carriers 4, 5. In FIGS. 7 and 8 the clamping clip is illustrated in a stationary operating state, resting on a workbench 37. The first clamping jaw carrier 4 with its actuating mechanism comprising the hand grip 17, clamping lever 23, and release handle 16 is situated in front of the edge of the workbench 37.

The second clamping jaw carrier 5 has a flat bearing surface 26 by means of which the clamping jaw carrier 5 rests on the surface of the workbench 37. The slides 27, 28 form bearing surfaces 27′, 28′ aligned with this bearing surface 26, so that the entire hand tool may be placed on the workbench 37 having a track 1 running in parallel but at a distance therefrom, so that the two arms 21, 22 bearing the clamping jaws 2, 3 point upward. Since the track 1 can be pushed through both clamping jaw carriers 4, 5, the tilting torque acting on the slide 28 may be adjusted so that it holds the tool on the workbench 37.

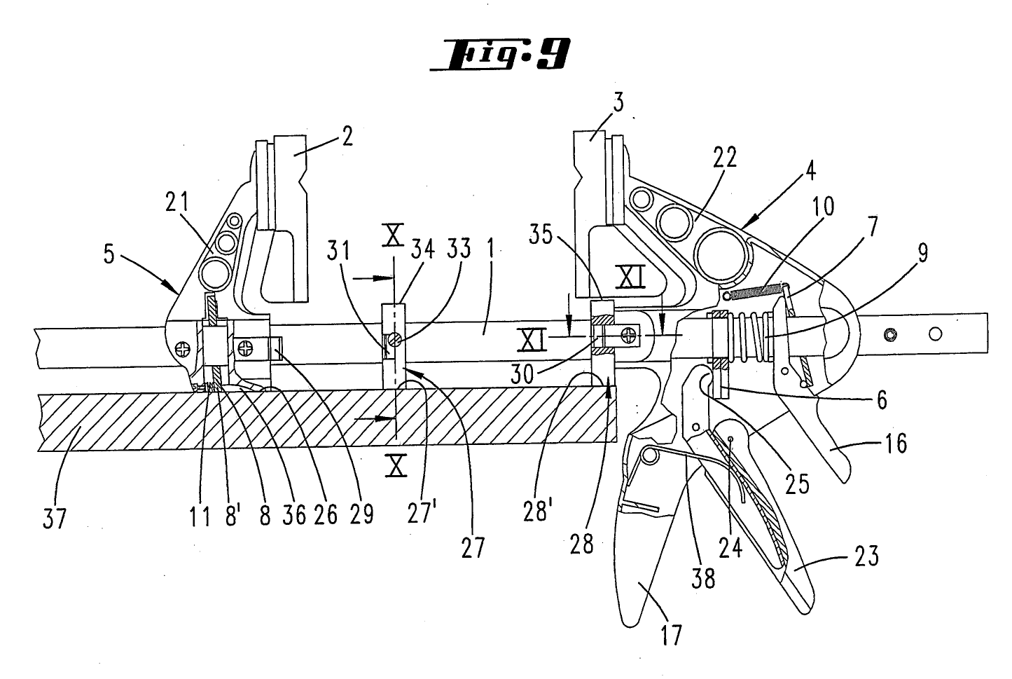

In the illustration according to FIG. 7, both slides 28 and 27 are located between the clamping jaws 2, 3. The narrow sides 34, 35 of the slides situated opposite from the bearing surfaces 27′, 28′ form supporting surfaces for a workpiece to be clamped between the clamping jaws 2 and 3. In the illustration according to FIG. 9, the slide 28 associated with the first clamping jaw carrier 4 is in a contact position on the first clamping jaw carrier 4, a spring tongue 30 passing through an opening in the slide 28, which has an essentially square cross section, in order to engage from behind with a locking step 32 by means of a locking projection.

Also associated with the slide is a clamping screw 33 which acts on the wide side of the track 1 and passes through an aperture in the slide to enable tight displacement of the slide 28 or the slide 27 on the track 1.

A spring tongue 29 is also associated with the second clamping jaw carrier 5. However, the spring tongue does not pass through an opening in the slide 27 with which it is associated, but instead projects into a wall recess which forms the locking shoulder 31.

The stepped shifting gear mechanism for the clamping jaw carrier 4 essentially corresponds to that described in DE 197 31 579 A1, for which reason reference is made to the embodiments contained therein. In essence, a clamping lever 23 displaces a pressure shoulder 25 against a drive lever 6. The distance between the pressure shoulder 25 and the rotational axis 24 of the clamping lever may be shortened by increasing the tensile force. The release handle 16 cooperates with a locking lever 7. By actuating the release handle 16 it is possible to move the locking lever 7 not only into a released position, but also to displace the locking lever 7 as a whole with respect to the housing of the first clamping jaw carrier 4, so that after the release handle 16 is released the tension spring 19 tightened by the displacement moves the entire clamping jaw carrier 4 in the direction away from the other clamping jaw carrier.

The second clamping jaw carrier 5 has a locking lever 8 which is held in a locked position by a helical compression spring 11 adjacent to the depression 36. The free end 8′ of the locking lever 8 projects into the depression 36 in such a way that the free end may be impinged on by the finger of an actuator to displace the locking lever 8 into the released position. It is essential that the end 8′ of the locking lever 8 does not project beyond the plane 26. The locking lever 8 cannot be actuated when the clamping jaw carrier 5 is resting on the bearing surface 26.

In each of the drawings only one spring tongue 29 or 30 is illustrated. However, it is preferable for each of the two clamping jaw carriers 4, 5 to have such a spring tongue on each side.

The exemplary embodiment illustrated in FIGS. 12 through 16 essentially corresponds to that described in DE 197 31 579 A1, with the exception of the clamping jaws 2, 3, which are pivotably associated with the arms 21, 22.

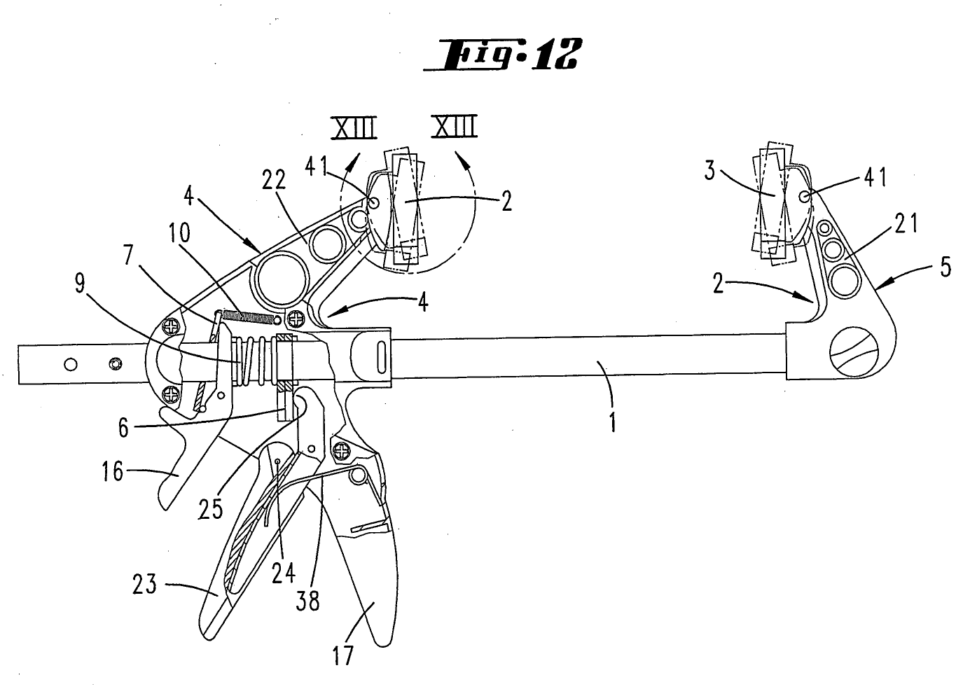

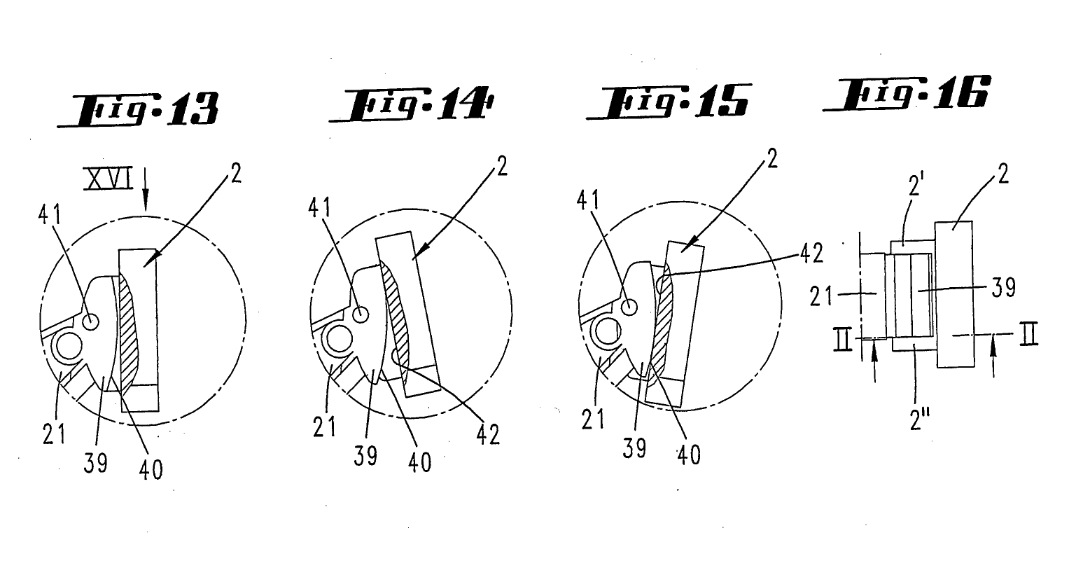

As shown in FIGS. 13 through 16, the clamping jaw 2 has two flanks 2′, 2″, separated at a distance from each other, by which the clamping jaw 2 is attached to a base 39 of the arm 21 or 22 by means of a pin at axis 41 so as to be pivotably movable. There is a gap between the rounded or roof-like surface 40 of the base 39 and the back side 42 of the clamping jaw. However, when it assumes one of the two extreme inclination positions illustrated in FIGS. 15 and 14, the back side 42 of the clamping jaw makes tangential contact with the surface 40.

All disclosed features (as such) are essential to the invention, and also have independent significance for the purposes of the claims. In the disclosure of the present patent application, the disclosed contents of the associated/accompanying priority documents (copy of the previous application) in their entirety are also incorporated herein, also for the purpose of incorporating features of said documents in the claims of the present patent application.

It should be understood that various changes and modifications to the presently preferred embodiments described herein will be apparent to those skilled in the art. Such changes and modifications can be made without departing from the spirit and scope of the present invention. It is therefore intended that such changes and modifications be covered by the appended claims.

1. A clamping tool, comprising: a clamping clip having first and second clamping jaw carriers which are associated with a track and which respectively bear a clamping jaw wherein at least the first clamping jaw carrier can be displaced along the track in one direction by a stepped shifting gear mechanism and is prevented from moving in the opposite direction by a releasable return locking element, and wherein the second clamping jaw carrier also has a releasable return locking element and can be displaced along the track.

2. The clamping tool according to claim 1, wherein the stepped shifting gear mechanism and/or the return locking element has a clamping lever which may be displaced against the restoring force of a spring and which has at least one clamping edge for tilting with the track.

3. The clamping tool according to claim 2, wherein the clamping lever has an aperture through which the track passes, and has two diametrically opposed clamping edges.

4. The clamping tool according to claim 1, wherein the first clamping jaw carrier cooperates with a spring which at one end is supported on the track and at the other end is supported on the first clamping jaw carrier.

5. The clamping tool according to claim 4, wherein the spring supported on the end of the track impinges on the clamping jaw carrier in the clamping direction, and the return locking element acting in the opposite direction exerts a retention force, directed opposite to the spring elastic force and exceeding same, which may be eliminated by the release actuation of the return locking element.

6. The clamping tool according to claim 1, wherein the first clamping jaw carrier may be displaced against a track stop by the clamping jaw spring.

7. The clamping tool according to claim 2, wherein the clamping lever of the return locking element is rigidly connected to a release handle.

8. The clamping tool according to claim 7, wherein the release handle passes through an aperture in a hand grip.

9. The clamping tool according to claim 7, wherein the release handle may be moved against the restoring force of a leaf spring from a locked to a released position.

10. The clamping tool according to claim 9, wherein the leaf spring impinges with its one end on a projection of the clamping lever which bears the release handle, and on its other end is fixed to the wall of a grip cavity.

11. The clamping tool according to claim 1, wherein each of the two clamping jaws may be swiveled about a respective axis at an end of an arm of the associated clamping jaw carrier, whereby the end of the arm forms a rounded or roof-like surface, and the surface is associated with a stop base to which two flanks of the clamping jaws are connected in such a way that the clamping jaws at both of its extreme inclination positions makes tangential contact with the surface at one respective section of the back side of the clamping jaw.

12. The clamping tool according to claim 1, wherein each of the two clamping jaws may be swiveled about a respective axis at an end of an arm of the associated clamping jaw carrier, whereby the end of the arm having a rounded surface forms a support base to which two flanks of the clamping jaws are connected in such a way that the back side of the clamping jaw is supported on the rounded surface in any swiveled position.

13. A clamping tool, comprising: a clamping clip, having first and second clamping jaw carriers which are associated with a track and which respectively bear a clamping jaw, wherein at least the first clamping jaw carrier can be displaced along the track in one direction by a stepped shifting gear mechanism and is prevented from moving in the opposite direction by a releasable return locking element, and at least one slide which is displaceably associated with the track between the two clamping jaw carriers and which forms a supporting surface for a workpiece.

14. The clamping tool according to claim 13 wherein, at least one slide has a bearing surface facing away from the supporting surface.

15. The clamping tool according to claim 14, wherein the bearing surface for the slide is aligned with a bearing surface for the second clamping jaw carrier.

16. The clamping tool according to claim 15, wherein an actuating section of a clamping lever for the second clamping jaw carrier projects into a depression associated with the bearing surface.

17. The clamping tool according to claim 16, wherein a spring impinging on the clamping lever is associated with a border of the depression.

18. The clamping tool according to claim 14, wherein each slide makes a respective clip connection with one clamping jaw carrier.

19. The clamping tool according to claim 18, wherein the clip connection is formed by a spring tongue which is associated with the clamping jaw carrier and which engages with a corresponding catch recess in the slide.
